(19) United States
(12) Patent Application Publication
(10) Pub. No.: US 2025/0212926 A1
(43) Pub. Date: Jul. 3, 2025

(54) PLANT-ONLY GUMS (3) REPLACEMENT SYSTEM IN FOOD PRODUCTS AND METHODS OF PREPARATION THEREOF

(71) Applicant: The Live Green Group, Inc.,, Middletown, DE (US)

(72) Inventors: Sasikanth Chemalamudi, San Fernando (CL); Priyanka Srinivas, San Fernando (CL)

(21) Appl. No.: 18/850,090

(22) PCT Filed: May 12, 2023
(86) PCT No.: PCT/IB2023/054924

§ 371 Date: Sep. 27, 2024

Related U.S. Application Data
(60) Provisional application No. 63/341,029, filed on May 12, 2022.

(51) Int. Cl. A23L 29/231; A23L 29/212; A23L 29/238

(52) U.S. Cl. CPC A23L 29/231; A23L 29/212; A23L 29/238

(57) ABSTRACT

A plant-only gum replacement system in food products is provided. The plant-only gum replacement system is prepared by mixing a) 20-30% by weight of a plant-derived polysaccharide source, b) 15-25% by weight of a plant-derived mucilage source, c) 20-30% by weight of a plant-derived pectin source, and d) 5-15% by weight of a plant-derived starch and protein source at a temperature between 60 degrees Celsius and 105 degrees Celsius for about 30 seconds to one minute. The plant-only ingredients of the gum replacement system effectively function as binders, agents for retaining moisture and improving cooking yields of consumable food products. These ingredients replace conventional, synthetic or highly processed and non-plant-derived additives and gums normally found in Traditional Burger Products and other commercially available food products.

### CROSS-REFERENCE TO RELATED APPLICATIONS

This application claims priority to the U.S. provisional patent application No. 63/341,029, filed on May 12, 2022 and PCT provisional patent application no.: PCT/IB2023/054924, filed on May 12, 2023, titled “PLANT-ONLY GUMS (3) REPLACEMENT SYSTEM IN FOOD PRODUCTS AND METHODS OF PREPARATION THEREOF” and is incorporated herein by reference.

### TECHNICAL FIELD

The disclosed embodiments relate generally to food compositions and, more particularly, relates to a plant-only gums replacement system, replacing the chemical, synthetic and/or highly processed gum additives in commercially available food products such as animal- or plant-based burgers, burger mixes, other meat-based products, meat alternative products, frozen food products, baked goods and other food products, including food product mixes in which the functionality of one or more gums may be desired to bind ingredients together, retain moisture and improve cooking yields of a food product. Such plant-only replacements are minimally processed and are free of synthetic food additives.

### BACKGROUND

Many commercially available, processed plant-based and animal-based food products contain natural and/or synthetic food additives as well as other highly processed ingredients. The categories of commercially available food products containing such additives vary greatly, and include animal flesh-based (i.e., any one or more of beef, pork, poultry, fish, shellfish, other seafood, etc.) or imitation meat-containing products based in whole or in part on plant-derived materials, or food products comprised of a combination both animal-source and plant-sourced materials. As an example, these food products may be, in one form, commercially available burgers and burger mixes, patties, cakes, crumbles, etc. Additives are found in all types of commercially available food products, and serve as stabilizers, preservatives, colorants, flavor enhancers, sweeteners, thickeners, texturizers, and emulsifiers, and provide a variety of desired characteristics such as flavors, textures, appearance, and consistency. Additives such as gums can maximize yield, minimize shrinkage and cooking loss, improve moisture retention, texturize, thicken, stabilize, emulsify, bind, and/or lead to more uniform blending or homogeneity to the food product or food product mix.

Together, all of the meat-based and/or plant-based meat alternative food products available commercially in any form will be referred to as “Traditional Burger Products,” despite their origin or form. These are distinguished from the plant-only burgers and burger mixes, collectively, plant-only “burger products,” as well as the plant-only gum replacement system of the disclosed embodiments. These terms are discussed in more detail and the categories distinguished further below.

Commercially available, Traditional Burger Products are generally highly processed foods. Traditional, meat-based burgers contain meat or animal flesh of some kind, added saturated fats, bone (carcass), highly processed ingredients, synthetic additives and other ingredients that may be inappropriate for certain diets, e.g., vegetarian, vegan, salt-restricted, low-fat, low saturated fat, culturally- or religiously-restricted diets etc. Even some commercially available “plant-based,” “plant-derived,” “meatless,” and “meat-free” burgers and other food products (depending on how those terms are defined by the manufacturers, or under definitions supported by a governmental authority in the location of manufacture) may contain animal-derived ingredients such as bone and meat broth or gelatin, dairy products and certain saturated fats, sourced from animals slaughtered for food, or from animals raised primarily for dairy product production. Such animal-derived additions can render even these “plant-based” burgers and burger mixes inappropriate for vegetarians and vegans.

Some meat substitutes have been developed, in part, to mimic the qualities that some consumers of plant-based alternatives desire in a burger: a juicy center, red color and meaty (or umami) taste but often a significant amount of saturated fat must be added to achieve a desired consistency or texture. Food additives in Traditional Burger Products may have physiological effects many consumers do not want or do not want to risk if a healthier, more sustainable alternative is available that does not pose the downsides. Examples of food additives commonly found in Traditional Burger Products include silicon dioxide, sodium benzoate, sodium nitrite, and artificial food colors. Many such additives (particularly synthetic additives) can be harmful to consumers if consumed over prolonged periods. The food industry uses more than 7,000 synthetic and ultra-processed additives even though nature offers more than ten million compounds from more than 450,000 plants.

Gums (hydrocolloids) are additives and are commonly used to bind ingredients together, emulsify, stabilize, help retain moisture and thicken, modifying the textural and structural properties of the food products in which they are used. Gums commonly used as additives in the food industry include, among others, carrageenan gum, which helps retain moisture in a food product, gum arabica, which increases moisture retention, guar gum, which improves cooking yield and consistency and acts as a binding agent, and xanthan gum, which also improves cooking yield. Konjac gum and starches are also commonly used. When gums come into contact with water, they form a gel; they modulate the thickening, emulsifying, smoothing, and gelling properties of aqueous foods. Gums traditionally used in meat-based burgers include those listed above, as well as gum tragacanth, gum from Detarium mirocanepum and gum from Mucuna flagellipes. Gums traditionally used in so-called plant-based burgers include (in addition to guar gum and carrageenan gum), gellan gum (thickener, binder and stabilizer), locust bean gum (structure, firmness, and heat stability), acacia and oat gums (texturizer, emulsifier and stabilizer), mucilaginous gum/flax gel (moisture retention, binding), and methylcellulose (binding, improvement of consistency, texturizer).

It would be desirable to provide solely plant- or fungi-derived (hereafter, “plant-only,” as further defined below) ingredients that replace highly processed, synthetic, artificial and/or animal-derived (i.e., sourced directly or indirectly from an animal) gums found in meats and meat substitutes such as Traditional Burger Products, as well as in breads and other baked goods. A “plant-only” food product is free from dairy and other animal-derived ingredients and is minimally processed, with—or, as a component of another food product, contributing to—a desirable flavor, taste, texture, homogeneity, consistency, color and appearance so as to be aesthetically pleasing to consumers.

### SUMMARY

Aspects of the disclosure are provided herein for a plant-only gum replacement system and components thereof to be used in place of commercially available synthetic or processed gums in a variety of food products. The selection of plant-only ingredients and combinations of ingredients selected by a machine learning platform provide effective functionalities for gums in food products, including meat substitutes. Commercially available, meat-based and/or imitation meat based food products such as highly processed plant-based, plant-derived, meatless or meat-free burgers, burger mixes and other types of imitation meats and meat-alterative products (together, “Traditional Burger Products”) are one category of food products that can benefit from substitution of commercially utilized gums for plant-only, non-synthetic ingredients and additives that are minimally processed. In the disclosed embodiments of the gum replacement system, plant-only gum replacers effectively function as binders, agents for retaining moisture and improving cooking yields of consumable food products (i.e., category 3 gum replacement functionalities). These ingredients replace conventional, synthetic or highly processed and non-plant-derived additives and gums normally found in Traditional Burger Products and other commercially available food products. In the disclosed embodiments, plant-only food additive replacements (or replacement systems) are comprised of only minimally processed, naturally occurring (i.e., non-synthetic) ingredients sourced solely within the plant or fungi kingdoms.

According to an aspect of the disclosed embodiments, a plant-only gum replacement system for use in food products is provided. The plant-only gum replacement system includes 20-30% by weight of a plant-derived polysaccharide source, b) 15-25% by weight of a plant-derived mucilage source, c) 20-30% by weight of a plant-derived pectin source, and d) 5-15% by weight of a plant-derived starch and protein source.

According to an embodiment, the plant-derived polysaccharide source is selected from almond polysaccharides, oat flour, quinoa flour, cassava flour, sunflower seeds flour, palm kernel meal, coconut flour, soya bean hulls, sugar beet pulp, pecan flour, cashew flour, macadamia flour or combinations thereof.

According to another embodiment, the plant-derived mucilage source is selected from quince seed mucilage, sweet basil seed mucilage, chia seed mucilage, yellow mustard mucilage, moringa seeds mucilage, fenugreek seeds mucilage, Cordia dichotoma seeds mucilage, arugula seeds mucilage, radish seeds mucilage, cress seeds mucilage, okra mucilage or combinations thereof.

According to yet another embodiment, the plant-derived pectin source is selected from tomato pomace, apple pomace, jujube pomace, redcurrant pectin, blackberry pectin, strawberry pectin, orange pomace, dragon fruit peel pectin, raspberry pectin or combinations thereof.

According to yet another embodiment, the plant-derived starch and protein source is selected from chickpea flour, pea flour, lupine flour, soy flour, pigeon pea, pinto beans flour, red lentils flour, lima beans, navy bean, mung bean, black gram flour, yellow pea flour or combinations thereof.

According to yet another embodiment, the food products comprise ice creams, pasta, processed cheese, tomato ketchup, soups, pastry ices, soft viscous candies, fruit-based and membrane-coated items, burgers, sausages, burger mixes, cakes, chocolate bars, and pancake mixes.

According to another aspect of the disclosed embodiments, a method of preparing a plant-only gum replacement system for use in food products is provided. The method includes mixing a) 20-30% by weight of a plant-derived polysaccharide source, b) 15-25% by weight of a plant-derived mucilage source, c) 20-30% by weight of a plant-derived pectin source, and d) 5-15% by weight of a plant-derived starch and protein source at a temperature between 60 degrees Celsius and 105 degrees Celsius for about 30 seconds to one minute to form the plant-only gum replacement system.

According to an embodiment, the plant-derived polysaccharide source is selected from almond polysaccharides, oat flour, quinoa flour, cassava flour, sunflower seeds flour, palm kernel meal, coconut flour, soya bean hulls, sugar beet pulp, pecan flour, cashew flour, macadamia flour or combinations thereof.

According to another embodiment, the plant-derived mucilage source is selected from quince seed mucilage, sweet basil seed mucilage, chia seed mucilage, yellow mustard mucilage, moringa seeds mucilage, fenugreek seeds mucilage, Cordia dichotoma seeds mucilage, arugula seeds mucilage, radish seeds mucilage, cress seeds mucilage, okra mucilage or combinations thereof.

According to yet another embodiment, the plant-derived pectin source is selected from tomato pomace, apple pomace, jujube pomace, redcurrant pectin, blackberry pectin, strawberry pectin, orange pomace, dragon fruit peel pectin, raspberry pectin or combinations thereof.

According to yet another embodiment, the plant-derived starch and protein source is selected from chickpea flour, pea flour, lupine flour, soy flour, pigeon pea, pinto beans flour, red lentils flour, lima beans, navy bean, mung bean, black gram flour, yellow pea flour or combinations thereof.

According to yet another embodiment, the food products comprise ice creams, pasta, processed cheese, tomato ketchup, soups, pastry ices, soft viscous candies, fruit-based and membrane-coated items, burgers, sausages, burger mixes, cakes, chocolate bars, and pancake mixes.

According to yet another embodiment, physical characterization data associated with ingredients of the plant-only gum replacement system comprising the plant-derived polysaccharide source, the plant-derived mucilage source, the plant-derived pectin source, and the plant-derived starch and protein source is stored in a database, wherein a machine learning model determines a unique combination of ingredients based on the physical characterization data to prepare the plant-only gum replacement system.

According to yet another embodiment, the physical characterization data of the ingredients comprise functional properties that comprise emulsification properties, stabilization properties, gelling properties, fat-replacement properties, Ayurvedic and/or other holistic properties, physicochemical properties that comprise pH, viscosity, moisture content, density, mechanical properties that comprise adhesive strength, tensile strength, shear resistance, chemical and/or molecular descriptor properties that comprise bio-active/bioavailability properties, molecular structure, phytonutrient properties, sensorial properties that comprise taste, smell, color, texture, mouth feel, and nutritional information that comprises macronutrient/micronutrient properties.

Several aspects of the disclosed embodiments are described below with reference to examples for illustration. However, one skilled in the relevant art will recognize that the disclosed embodiments can be practiced without one or more of the specific details or with other methods, components, materials, and so forth. In other instances, well-known structures, materials, or operations are not shown in detail to avoid obscuring the features of the disclosed embodiments. Furthermore, the features/aspects described can be practiced in various combinations, though only some of the combinations are described herein for conciseness.

### BRIEF DESCRIPTION OF THE DRAWINGS

Example embodiments of the disclosed embodiments will be described with reference to the accompanying drawings briefly described below.

FIG. 1 illustrates a flow chart of a method of preparing a plant-only gum replacement system in food products according to the aspect of the present disclosed embodiments.

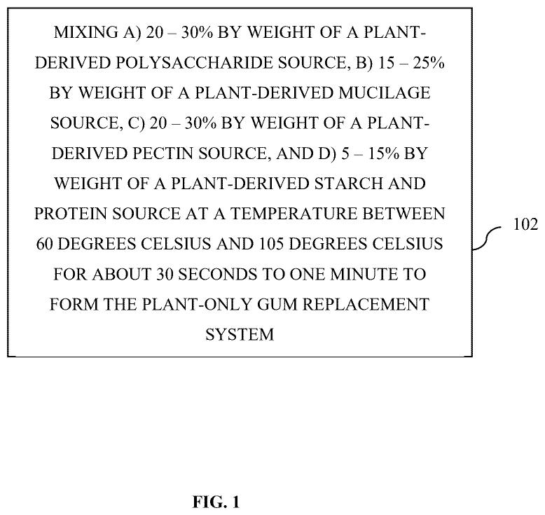

In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE DISCLOSED EMBODIMENTS

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced items. Further, the use of terms “first”, “second”, and “third”, and the like, herein do not denote any order, quantity, or importance, but rather are used to distinguish one element from another. Further, the terms “comprising,” “including,” “having,” and the like, as used with respect to embodiments of the present disclosure, are synonymous. As used herein, the terms “agent,” “component,” or “ingredient” are used interchangeably and refer to a particular item that includes one or more chemical compounds (e.g., a food item from one or more plants that comprise one or more naturally occurring chemical compounds).

The term “component” or “ingredient” as used herein, refers to a particular item that includes one or more chemical compounds, i.e., edible compounds sourced from plants, fungi or algae that comprise one or more naturally occurring chemical compounds.

Alternative embodiments of the present disclosure and their equivalents may be devised without parting from the spirit or scope of the present disclosure. It should be noted that any discussion herein regarding “one embodiment”, “an embodiment”, “an exemplary embodiment”, and the like indicate that the embodiment described may include a particular feature, structure, or characteristic and that such particular feature, structure, or characteristic may not necessarily be included in every embodiment. In addition, references to the foregoing do not necessarily comprise a reference to the same embodiment. Finally, irrespective of whether it is explicitly described, one of ordinary skill in the art would readily appreciate that each of the particular features, structures, or characteristics of the given embodiments may be utilized in connection or combination with those of any other embodiment discussed herein.

As used herein, the singular forms “a”, “an”, and “the” include both singular and plural referents unless the context clearly dictates otherwise. By way of example, “a dosage” refers to one or more than one dosage.

The terms “comprising”, “comprises” and “comprised of” as used herein are synonymous with “including”, “includes” or “containing”, “contains”, and are inclusive or open-ended and do not exclude additional, non-recited members, elements or method steps.

All documents cited in the present specification are hereby incorporated by reference in their totality. In particular, the teachings of all documents herein specifically referred to are incorporated by reference.

Example embodiments of the disclosed embodiments are described with reference to the accompanying FIGURES.

In the drawings, like reference numbers generally indicate identical, functionally similar, and/or structurally similar elements. The drawing in which an element first appears is indicated by the leftmost digit(s) in the corresponding reference number.

### Definitions

“gum” refers to a food additive used to add stickiness, thicken, prevent separation of ingredients, and improve texture.

“polysaccharide” refers to long chains of carbohydrate molecules composed of several smaller monosaccharides.

“mucilage” refers to a viscous or gelatinous secretion from plant roots, seeds, etc. “pectin” refers to a complex starch derived from plants.

“Starch” refers to a polymeric carbohydrate consisting of numerous glucose units.

“Proteins” refers to large biomolecules and macromolecules that comprise one or more long chains of amino acid residues.

“Bulking” refers to increasing the volume or weight of a product without affecting the overall taste and aroma of the product.

“Texturizing” refers to improving the overall consistency, texture by enhancing features like creaminess, viscosity, mouthfeel and taste.

“Fat” refers to a type of lipid consisting of triesters of glycerol and fatty acids or triglycerides.

“Fruit puree” refers to making fruit or vegetables into a thick, smooth sauce by crushing.

“Derived sugars” refers to modified monosaccharides.

“Cream” refers to a thick yellowish-white liquid.

“Emulsifier” refers to an agent used to help mix two substances that typically separate when they are combined.

“Thickener” refers to a substance that increases the viscosity of a liquid without substantially changing its other properties.

“Stabilizer” refers to an additive to food that helps to preserve its structure. “Flavoring agent” refers to an additive that provides an additional taste or flavor.

“Homogeneous mixture” refers to a mixture that has the same proportions of its components throughout a given sample.

“Blender” refers to an appliance used to mix, crush, purée or emulsify food and other substances.

“Machine learning model” refers to computer software designed to recognize patterns or behaviors based on previous experience or data.

“Plant-derived” refers to ingredients extracted from a plant.

“Plant-only” products disclosed herein, as opposed to products labeled as “plant-based,” and the like, refer to food products whose ingredients, apart from any significant amount of water added, are derived solely from sources outside of the animal kingdom, e.g., from plants, fungi, or algae. That is, “plant-only” may refer to any composition, formulation, system or the entire food product, that is produced, developed, or otherwise obtained directly or indirectly from one or more plants, fungi, or algae, is not synthetic, and is only minimally processed for production, e.g., cleaned, dried, pulverized, etc.

The term “food product” refers broadly to any edible food or product, raw or cooked, savory or sweet, whether intended for human or animal consumption; a food product may be edible although not intended to be consumed on its own but, rather, incorporated into a second (or third) food product that is considered a consumable.

The Applicant, Live Green Company, is the market maker of the Plant-only category, which means that all the animal, synthetic and ultra-processed ingredients are replaced by plant-derived ingredients with superior nutritional profiles without impacting the original organoleptic properties.

A plant-only food product or formulation that is free from dairy and other animal-based ingredients is described herein that has desirable flavor, taste, texture, homogeneity, consistency, color and appearance so as to be aesthetically pleasing prior to consumption. The terms “plant-derived is used,” in this disclosure to refer to any ingredient, or component of a food product that is derived or extracted or obtained from plants with minimal processing. The term plant-only is used in this disclosure to refer to a system, composition, formulation or the entire food product itself, that is produced, developed or otherwise obtained directly or indirectly from one or more of the plant-derived ingredients, component that is obtained from plants with minimal processing. Although a plant-only, food product may consist of materials that are 100 percent sourced from one or more plants, the term also encompasses food products that may contain components or ingredients that are not obtained from plants. For example, while some of the water content of a food product may be derived from a plant source, water may also be added to the product from an external source. For example, in scenarios in which a plant-only system or plant-only food product is in the form of a gel or liquid, it is further understood that water can be included as a solvent or liquid carrier for the plant-only system or plant-only food product, where any amount of water (some or all) within the system or food product may or may not be derived from a plant source. In some embodiments, apart from added water, the plant-only food product consists entirely (100%) of components or ingredients from a plant genus (i.e., photosynthetic eukaryotes from the kingdom Plantae), and further excluding any component or ingredient that is dairy-based, that is from the animal genus (including animal fats and animal proteins) and also excludes any synthetically derived component or ingredient. The plant-derived ingredients of the food product described herein replace conventional animal-based ingredients, including milk, cream and eggs, as well as conventional additives such as gums, stabilizers, emulsifiers, preservatives, anti-freezing and anti-caking agents, binders, etc. The product formed solely from plant-derived ingredients is further free from gluten, soy, cholesterol and trans fatty acids.

The selection of specific plant-derived ingredients, or specific combinations (i.e., systems) of plant-derived ingredients provide effective functionalities such as emulsifiers, stabilizers, texturizing and thickening, fat replacement, sugars or other sweeteners, anti-freezing properties, anti-caking properties, etc., for the food product without the need to add such conventional, non-plant-derived additives. As used herein, the terms “agent,” “component,” or “ingredient” are used interchangeably and refer to a particular item that includes one or more chemical compounds (e.g., a food item from the plant species that comprises one or more naturally occurring chemical compounds). The term “plant-derived”, as used herein, refers to a product or formulation (e.g., food product or food formulation).

Embodiments disclosed herein include the plant-only gum replacement system (category 3, as described below), or components of it, for replacing various gums traditionally found in commercially available food products, including Traditional Burger Products. In some embodiments the gum replacement system or aspects of the system may replace part of the meat or fibrous material as well as the additives of a (meat-based or plant-derived) Traditional Burger Product. In other embodiments, the gum replacement system or components of it complement the ingredients of plant-based or plant-derived Traditional Burger Products, by providing more plant-only sources that enhance the nutritional or aesthetic value (e.g., flavor) of the food product. In still other embodiments the gum replacement system's plant-only ingredients may replace any-even partially-animal-derived ingredients of, so-called “plant-derived,” “plant-based” or meatless, imitation meat food products, including food product mixes.

The disclosed plant-only gum replacement system (as a food product itself, or for inclusion in other food products) relates to non-synthetic, unprocessed or minimally processed, substitute ingredients for the gums commonly used in commercially available food products. Specifically, the gum substitutes in the replacement system embodiments disclosed herein (category 3) are agents that bind ingredients, help retain moisture and improve food product yields during cooking. The category 3 gum replacement system in some embodiments is added to other ingredients to form consumable food products. Other gum replacement systems comprise gum substitutes that alter the consistency and reduce cooking loss (category 1); and those that texturize, thicken, bind, emulsify and stabilize food products (category 2); each of these is the subject of a separate disclosure. The focus of this disclosure is category 3 gum replacements, which may be used or sold, in some embodiments, alone to be added by the purchaser to make a consumable food product or, in other embodiments, to be used in combination with either category 1, or category 2 gum replacement systems, as well as other ingredient replacement systems in the same consumable food product(s). The food systems of the present embodiments may be mixed with other ingredients and other plant only replacement systems to form one or more consumable food products.

“Plant-only” products disclosed herein, as opposed to products labeled as “plant-derived,” “plant-based,” “meatless,” “meat-free” and the like, refer to food products whose ingredients, apart from any significant amount of water added, are derived solely from members of the plant or fungi kingdoms. That is, “plant-only” may refer to any agent, ingredient, or component of a food product, or the entire food product itself, that is produced, developed, or otherwise obtained directly or indirectly from one or more plants or fungi, is not synthetic, and is only minimally processed for production, e.g., cleaned, dried, pulverized, etc.

While some manufacturers may refrain from including any ingredients sourced from animals in their “plant-based” (and other similarly labeled) products, the term “plant-based” may also encompass ingredients and food products that may be obtained from outside the plant or fungi kingdoms. The US Food and Drug Administration currently has no accepted standard definition for labeling of food products described as “plant-based” or “plant-derived,” although a private trade organization, the Plant Based Food Association, has proposed voluntary standards to ensure consistency when the term “plant-based” is used on a product label (i.e., it contain no animal-sourced content), and seeks to certify-through its certification process-food products, including food product, mixes that meet this standard (https://www.plantbasedfoods.org/policy/labeling/). The terminology used on a label for a plant-based food must be truthful under FDA regulations; however, in the US no regulatory body currently requires a company to refrain from including some amount of meat (animal flesh) or other animal-sourced ingredients in a “plant-based” product.

In certain embodiments, while some of the water content of a food product may be derived from a plant source, water may also be added to the product from an external source. For example, in scenarios in which a plant only agent or system or plant only food product is in the form of a gel or liquid, it is further understood that water can be included as solvent or liquid carrier for the plant-only system, ingredient or food product, where any amount of water (some or all) within the system, ingredient or food product may or may not be derived from a plant source. In some embodiments, water may be added from an external source as part of the plant-only gum replacement system (or any other plant-only replacement system referenced herein). In other embodiments the plant only gum replacement system may be available in a dried form; in certain embodiments the dried form may be powdered; in other embodiments, the dried form of the gum replacement system may be in a partially powdered form; in other embodiments it may be available in a semi-liquid or gel form; in other embodiments it may be in a liquid or frozen form.

In the disclosed embodiments, apart from externally-sourced water, the plant-derived food product consists entirely of ingredients derived from members of the plant or fungi kingdoms, excluding any component or ingredient that is: (i) dairy-based or otherwise derived from any member of the animal kingdom; and (ii) more than minimally processed; and (ii) synthetic. In some embodiments, the plant-only gum replacement system, or components thereof, replace conventional ingredients and additives found in meat-based food products such as commercially available meat-based burgers. In other embodiments the gum replacement system replaces those additives found in commercially available plant-based, plant-derived, meatless, meat-free food products that range from burgers and burger mixes to baked goods and frozen food products.

Alternative embodiments of the present disclosure and their equivalents may be devised without parting from the spirit or scope of the present disclosure. It should be noted that any discussion herein regarding “one embodiment”, “an embodiment”, “an exemplary embodiment”, and the like indicate that the embodiment described may include a particular feature, structure, or characteristic, and that such particular feature, structure, or characteristic may not necessarily be included in every embodiment. In addition, references to the foregoing do not necessarily comprise a reference to the same embodiment. Finally, regardless of whether it is expressly described herein, one of ordinary skill in the art would readily appreciate that each of the particular features, structures, or characteristics of the given embodiments may be utilized in connection or combination with those of any other embodiment discussed herein.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

Further, the terms “comprising,” “including,” “having,” and the like, as used with respect to embodiments of the present disclosure, are synonymous. As used herein, the terms “agent,” “component,” or “ingredient” are used interchangeably and refer to a particular item that includes one or more chemical compounds (e.g., a food item from one or more plants that comprise one or more naturally occurring chemical compounds).

The term “component” or “ingredient” as used herein, refers to a particular item that includes one or more chemical compounds, e.g., a food item from a member of the plant or fungi kingdoms that comprises one or more naturally occurring chemical compounds.

### Functionality and Parameters

TABLE 1
Parameter ranges associated with ingredients of the
plant-only gum replacement system in food products

| Ingredients | Parameters & Ranges | | | | |
|---|---|---|---|---|---|
| Almond | Amount of | Swelling | Emulsion stability: | | |
| polysaccharides | polysaccharides/ | index: | ~45.83 to 92.6% | | |
| | Non starch | 22.58% to | or more | | |
| | polysaccharides: | 87.44 ± | The EC values | | |
| | 20%-92.36% or | 0.310% or | increase | | |
| | more | more | proportionally | | |
| | | | to almond gum | | |
| | | | concentrations | | |
| | | | (w/v). | | |
| Quince seed | Viscosity at | Water holding | Emulsion stability: | | |
| mucilage | shear rate of | capacity: | 35%-94.89% | | |
| | 46.16 1/s | ~10.27 g/g | | | |
| | ~1000 | to 92.50 ± | | | |
| | mPa · s or | 1.63 g/g | | | |
| | more | | | | |
| Tomato | Emulsion | Oil Holding | Water holding | | |
| pomace | stability | Capacity: | capacity | | |
| (pectin) | 35% to 80% | 2.97-11 g | 3-17 g/g | | |
| | or more | of oil/g of | or more | | |
| | | sample | | | |
| Chickpea | Gelatinization/ | Peak | WHC: | Emulsion | Swelling |
| flour | Pasting | viscosity | 1.81-2.63 g | stability: | power: |
| (starch/ | Temperature: | (cP) | water/g | 35-90% | 1.05 to |
| protein) | 60 C. to 80 C. | 1107-2173 | | or more | 21 g/g |
| | | cP | | | (range is |
| | | | | | temperature |
| | | | | | dependent, |
| | | | | | upper limit |
| | | | | | is taken |
| | | | | | at 100 C.) |

The selection of a specific combination of ingredients for plant-only products was determined using a proprietary machine learning (ML) platform, which blends ancestral wisdom of plant nutrition with biotechnology and ML to analyze members of the plant and fungi kingdoms and from plants and fungi, the compounds nature offers. The platform utilizes algorithms and includes a database with a significant number of ingredients (e.g., 50,000-100,000 ingredients) and relevant physical properties associated with such ingredients. For example, physical characterization data and information about each ingredient for some or all of the ingredients in the database include, without limitation, functional properties (e.g., emulsification properties, stabilization properties, bulking properties, texturizing properties, gelling properties, fat-replacement properties, etc.). Ayurvedic and/or other holistic properties, physicochemical properties (e.g. pH, viscosity, moisture content, density, etc.), mechanical properties (e.g. adhesive strength, tensile strength, shear resistance, etc.), chemical and/or molecular descriptor properties (e.g., bio-active/bioavailability properties, molecular structure, phytonutrient properties, etc.), sensorial properties (e.g., taste, smell, color, texture, mouth feel, etc.), and nutritional information (e.g., macronutrient/micronutrient properties, etc.) are also considered in the proprietary system to give optimal results in terms of functionality, health and sustainability. Based upon the known properties of ingredients in the database, the desired properties for the food product or formulation, and one or more algorithms associated with the proprietary machine learning platform, a unique combination of plant-only ingredients was determined to yield an effective gum replacement formulation that can be used to forming a desirable food product or formulation that is effective as a substitute for conventional ingredients in Traditional Burger Products or for providing gum-like functionality in plant-only burger products and other food products.

As noted, the proprietary system identifies natural alternatives, i.e., plant-only alternatives to synthetic, artificial, and animal-derived products, and incorporates, among other things, traditional knowledge known as Ayurvedic medicine. Ayurvedic medicine and its diet principles have been practiced for many thousands of years. This ancient system, among other things, categorizes food by its medicinal properties and desired effects; thus, the proper application of Ayurvedic principles requires knowledge of the self—one's dominant energy, also known as dosha—to prescribe the most advantageous categories of foods from which to choose for an individual's diet. Categories of Ayurvedic properties include but are not limited to Virya (hima/sheeta—cold), Vipaka (Madhura—sweet), Rasa (Madhura—sweet), and Guna (ruksha—dry; or guru—heavy). The information recommended by the proprietary machine learning platform permits one to choose between hundreds of alternatives based on ingredients intended to alter a variety of properties to give optimal results for physiological functionality, health, and environmental sustainability.

The physical characterization data associated with the ingredients of the plant-only gum replacement system in food products are stored in a database. A machine learning model determines a unique combination of ingredients based on the physical characterization data to prepare the plant-only gum replacement system. The machine learning model identifies plant-based ingredient replacements based on the parameters and ranges to give the list of ingredients for each possible functionality.

A food product as described herein that functions to replace gums in Traditional Burger Products or plant-only burger products comprises a combination of solely plant- or fungi-sourced ingredients and added water, if any is required for gum replacement preparation. The plant-only ingredients and combinations of ingredients selected for the gum replacement system are consistent with the requirements and specifications of achieving the functionalities exhibited by conventionally used gums when used in commercially available food products, including those containing meat substitutes.

### Example Embodiments

The disclosed embodiments are illustrated in further detail by the following non-limiting examples.

TABLE 2
Percent by weight of each of the preferred, essential,
gum replacement categories of ingredients in the plant-
only gum replacement system for in food products.

| | Preferred Dry Weight |
|---|---|
| Plant-Only Gum Replacement (Category 3) | Percent of the |
| System Preferred, Essential Ingredients | Replacement System |
| 1. Plant-derived polysaccharide source (i.e.) | 20-30 |
| Almond polysaccharides, oat flour, quinoa flour, | |
| cassava flour, sunflower seeds flour, palm kernel | |
| meal, coconut flour, soya bean hulls, sugar beet | |
| pulp, pecan flour, cashew flour, macadamia flour | |
| 2. Plant-derived mucilage source (i.e.) Quince | 15-25 |
| seed mucilage, sweet basil seed mucilage, chia | |
| seed mucilage, yellow mustard mucilage, moringa | |
| seeds mucilage, fenugreek seeds mucilage, | |
| Cordia dichotoma seeds mucilage, arugula seeds | |
| mucilage, radish seeds mucilage, cress seeds | |
| mucilage, okra mucilage | |
| 3. Plant-derived pectin source (i.e.) Tomato | 20-30 |
| pomace (pectin), apple pomace, jujube pomace, | |
| redcurrant pectin, blackberry pectin, strawberry | |
| pectin, orange pomace, dragon fruit peel pectin, | |
| raspberry pectin | |
| 4. Plant-derived starch and protein source (i.e.) | 5-15 |
| Chickpea flour (starch/protein), pea flour, lupine | |
| flour, soy flour, pigeon pea, pinto beans flour, | |
| red lentils flour, lima beans, navy bean, mung | |
| bean, black gram flour, yellow pea flour | |

Gums used as additives in commercially available food products generally texturize, thicken, bind, emulsify, stabilize and may also help retain moisture and improve cooking yields. Other types of highly processed or synthetic additives such as phosphates, maltodextrin, and others, have similar functionalities in food products and, as a result, the gum replacement system embodiments disclosed may replace those types of additives as well. Table 2 shows the percent by weight of each of the preferred, essential plant-only ingredients in the gum replacement system, whose functionalities include binding, retaining moisture and improved yield in food products in which these replacement ingredients are added.

Within this category 3 set of gum replacement ingredients, one ingredient (or an alternative plant-only ingredient exhibiting the same or similar functionalities and properties) may be used as the gum replacement system. In other embodiments two or more may be combined in varying amounts for the gum replacement system. In alternative embodiments, any of the ingredients listed may be replaced with one or more substitute ingredients that impart the same or similar properties and functionalities as each of the ingredients listed.

Further, although Table 2 provides a preferred, essential list of categories of ingredients with certain properties in the gum replacement system, substitutions for these ingredients in the replacement system may be made in alternative embodiments for compliance with dietary requirements; without limitation, such as food sensitivities and food allergies. The plant-only gum replacement system detailed in Table 2 as a component of a plant-only burger product (generally between about 0.05 to about 3, or between about 0.5 to about 5 percent dry weight of the total weight of a plant-based burger product in which it is mixed), or a Traditional Burger Product (e.g., conventionally meat- or plant-based, generally between about 1 and 15 percent of the total weight of the Traditional Burger Product) comprises but may vary between as much as 0.05 percent to about 25 percent or more of the total weight of the food product, depending on the moisture content of the gum replacement system and that of the final food product (e.g., whether a plant-only burger product (see Table 3) or a Traditional burger Product (see Tables 5 and 6), whether a dry mix or other form).

TABLE 3
Various replacement systems' ingredients and combinations
as components of plant-only burger products

| | Preferred Dry |
|---|---|
| Preferred, Essential, Plant-Only Food Product | Weight Percent of |
| Replacement Systems and/or Individual | Plant-Only Burger |
| Ingredients and Combinations | Product |
| Protein sources (one or more of pea, mushroom, | 10-20 |
| quinoa, chickpeas) | |
| Methyl Cellulose (MC) replacement system | 5-10 |
| ingredients from all five categories (proteins; | |
| fibers from whole grains, fruits, seeds and | |
| vegetables; starches; and vegetable binders) | |
| within the ranges indicated for the replacement | |
| system | |
| Modified Starches replacement system comprising | 10-15 |
| four starch source categories, including, among | |
| other ingredients, tapioca starch, faba bean | |
| starch, sorghum starch, quinoa starch and/or | |
| substitute(s) exhibiting similar or the same | |
| properties and functionalities) | |
| Oils providing high levels of omega-3 fatty acids, | 10-12 |
| MUFAs, & MCTs (e.g., sunflower oil, coconut oil, | |
| flaxseed oil, rice bran oil, or other oil providing | |
| such fats at desired levels) | |
| Gum replacement system(s), any one or more of | 10-15 |
| categories 1-3, depending on the desired | |
| characteristics of the plant only food product | |
| (category 1 gums - one or more of four preferred, | |
| essential ingredients: almond polysaccharides, | |
| quince seed mucilage, mesquite protein and linseed | |
| mucilage; category 2 gums - one or more of four | |
| preferred, essential ingredients: chickpea protein | |
| and starch, rice starch, quinoa starch, and apple | |
| pomace (pectin); category 3 gums - one or more | |
| of four preferred, essential ingredients: almond | |
| polysaccharides, quince seed mucilage, tomato | |
| pomace (pectin), and chickpea starch/protein, as | |
| well as and/or one or more substitute(s) for any | |
| of these ingredients exhibiting similar or the | |
| same properties and functionalities | |
| Shelf life extenders (one or more of garlic, | 1-2 |
| black pepper, oregano, bay laurel) | |
| Umami flavor (one or more of shitake and other | 0.5-2 |
| mushrooms, tomatoes, garlic, lotus stalk, onions, | |
| salt) | |
| Flavorant, flavor enhancer, nutraceutical (one or | 0.5-1 |
| more of cumin, coriander, paprika, black pepper) | |
| Flavor Enhancer (one or more of nutritional yeast, | 1-2 |
| cashews) | |
| Mineral Salts (Himalayan pink salt, sea salt, etc.) | 0.5-2 |
| Binding agents (one or more of chickpeas, oat fiber, | 5-10 |
| aquafaba, sugar beet pectin) | |
| Leavener replacement system ingredients from five | 0.5-1 |
| categories (plant-only fibers; fruit pectins; fruit | |
| acids; plant-only starches; and cereal sources) | |
| Leghemoglobin source(s) (one or more of beets, | 1-2 |
| soy, red radish) | |
| Lipid peroxidation inhibitors (one or more of | 0.5-2 |
| black pepper, bay leaf, cumin) | |

The gum replacement system may comprise, as a percent by weight of the food product in which it is added, depending on the type of food product and whether water or other liquid is included as part of the food product, included but not limited to Traditional Burger Products and plant-only burger products, between about 0.05 to about 25 percent or more, between about 0.05 and about 3 percent, between about 0.05 and 5 percent, between about 0.1 to about 0.5 percent, between about 0.1 to about 2 percent, between about 0.1 to about 5 percent, between about 0.2 to about 0.4 percent, between about 0.4 to about 0.6 percent between about 0.6 to about 0.8 percent, between about 0.8 to about 1 percent, between about 1 to about 1.2 percent, between about 1.2 to about 1.4 percent, between about 1.4 to about 1.6 percent, between about 1.6 to about 1.8 percent, between about 1.8 to about 2.0 percent, between about 2.0 to about 2.5 percent, between about 2 to about 3 percent, between about 3 to about 5 percent, between about 5 to about 10 percent, between about 10 to about 15 percent, between about 15 to about 20 percent, and between about 20 to about 25 percent.

Preferred, Essential Ingredients and their Interactions in the Category 3 Gum Replacement System

The preferred, essential ingredients listed in Table 2 were identified by the machine learning platform referenced above. One or more plant-only, minimally processed and non-synthetic alternative ingredients may also be used in the gum replacement system (or may replace one or more of the listed ingredients). Such alternatives may be known to a person of ordinary skill to exhibit the same or similar functionalities and properties as one or more of the preferred, essential ingredients in the category 3 gum replacement system.

Almonds are one example of a source of polysaccharides (gum) that can be used as part of a gum replacement system in food products. In some embodiments, almond polysaccharides are provided in the gum replacement system as a finely ground powder. In other embodiments they may be mixed with water, plant-derived liquid or other liquid to form a liquid, gel or other alternative form the system suitable for mixing and storing, freezing and/or drying. Almond polysaccharides promotes the ayurvedic properties of Rasa: Madhura (sweet), Guna: Snigdha (slimy), Guru (heavy), Virya: Ushna (hot), and Vipaka: Madhura (Sweet). This ingredient is further described in Table 8. Phytochemically, sweet almond contains carbohydrates, sterols, flavonoids, vitamins and phenolic compounds. Almonds provide gelling, binding and stabilizing properties to the food products in which almond flour, starch and proteins are added, improving texture and taste.

In the disclosed embodiments, almond polysaccharides and/or a substitute with the same or similar properties and functionalities as these ingredients as a percent of the gum replacement system weight, ranges from between about 10 to about 40 percent, between about 10 to about 15 percent, between about 15 to about 20 percent, between about 20 to about 25 percent, between about 20 to about 30 percent, between about 25 to about 30 percent, between about 30 and about 35 percent, and between about 35 to about 40 percent.

A unique blend of almond polysaccharides, quince seed mucilage and tomato pomace together, may act as a system of stabilizer and emulsifiers. Almond polysaccharides and chickpea protein reduce the interfacial tension between the oil and water phases and produce stable emulsions at low concentrations. The presence of various carbohydrates in these gums also help in stabilizing the emulsions as they form structured films. Even at temperatures above room temperature, gums stabilize emulsions. Creaming, which may occur as a consequence of unstable emulsion formation, is prevented by the addition of quince seed mucilage. Mesquite seeds provide a higher protein quality than soybeans, a well-known legume used by the food industry. When used with other gum replacement systems (categories 1 and/or 2), some ingredients such as, e.g., mesquite protein provide some of the same functionality as tomato pomace, referenced above in the combination. Both almond polysaccharides and quince seed mucilage have antioxidant and antibacterial properties, which aid in food preservation.

In some embodiments, quince seed mucilage is provided in the gum replacement system as a finely ground powder. In other embodiments they may be mixed with water, plant-derived liquid or other liquid to form a liquid, gel or other alternative form the system suitable for mixing and storing, freezing and/or drying. Quince seed mucilage promotes the ayurvedic properties of Rasa: Madhura (Sweet), Titka (Bitter), Kashaya (Astringent), Guna: Laghu (Light), Ruksha (Dry) Virya: Ushna (Hot), and Vipaka: Katu (Pungent).

In the disclosed embodiments, quince seed mucilage and/or a substitute with the same or similar properties and functionalities as these ingredients as a percent of the gum replacement system weight, ranges from between 5 to about 35 percent, between about 5 to about 10 percent, between about 10 to about 15 percent, between about 15 to about 20 percent, between about 15 to about 25 percent, between about 25 to about 30 percent, and between about 30 to about 35 percent.

Quince seed mucilage and almond polysaccharides exhibit high water binding capacity, retaining moisture during the cooking process. Quince seed mucilage in combination with linseed mucilage also reduce cooking loss.

Almond polysaccharides exhibit similar gelatinization properties to those of gum arabic, for example; their use results in delayed gelatinization of starch molecules. Both have high water binding capacities, which could diminish the gelatinization of starch particles since both would be competing for available water. While this could negatively affect binding in a burger product, the combination of almond polysaccharides with quince seed mucilage and other plant-only ingredients in a burger product such as chickpeas and pectins, will compensate for the lesser ability of almond polysaccharides alone to bind water. The combination in a plant-only burger product, for example can result in greater moisture retention in food products, resulting in reduced cooking loss. Food products containing conventionally used gums will not retain as much moisture through the cooking process.

Chickpea flour. Chickpeas, commonly known as garbanzo beans, are an old world pulse (i.e., edible seeds) in the legume family. The main proteins found in chickpeas, like other legumes, are albumins and globulins. The protein isolates and starches for matrices with higher water holding capacity, oil binding capacity, emulsion stability and emulsion activity than the starch fractions. The legume is a rich source of protein and carbohydrates, including starches, making it an excellent replacement for meat vegetarian and vegan dishes. Chickpeas are provided in the system as a finely ground powder (flour and/or starch/protein components). Chickpeas promote the ayurvedic properties of Rasa: Madhura (Sweet), Kashaya (Astringent), Guna: Laghu (light) Ruksha (dry) and Virya: Hima (Cold), as shown in Table 3.

The disclosed embodiments the amount of chickpea flour, including starch and protein components, as a percent of the gum replacement system weight ranges from between about 1 to about 25 percent, between about 1 to about 5 percent, between about 5 to about 10 percent, between about 5 to about 15 percent, between about 10 to about 15 percent, between about 15 to about 20 percent, and between about 20 and about 25 percent.

Tomato pomace (pectin), a by-product of processing tomatoes for juice and sauce, his high in protein, and carbohydrates and fat. Leucine in tomato peel/fiber pectin (TFP) is the main amino acid (1.46 g/100 g protein). Essential fatty acids represent 58.4% of total fatty acids, with linoleic acid as the most abundant (55.8%). Tomato pomace pectin, due to the higher level of fat present in the TFP, reduces cooking loss and shrinkage of meat- or plant-based (or plant-only) food products such as burgers. The replacement of traditionally used gums in food products with the (category 3) gum replacement system disclosed herein may also reduce production costs, without affecting functional and sensory properties of the consumable food product.

In general, pectins help form small droplet size emulsions, showing higher stability and formed gel-like matrices. Insoluble fibers maintain emulsion stability through the pickering mechanism and network formation in the continuous phase, likely favored by stabilization of proteins and pectins in the soluble fraction. Increasing tomato pomace pectin content maintains cooking yield (with a cooking loss of only 27.8 percent). The pectin in tomato peel increases springiness, while cellulose and lignin increase chewiness of a burger, for example. Tomato pomace pectin promotes the ayurvedic properties of Rasa: Madhura (Sweet); Sour (Amla); Guna: Guru (Heavy to digest); Virya: Sheeta (Cold); Vipaka: Sour (Amla).

The disclosed embodiments the amount of tomato pomace (pectin) as a percent of the gum replacement system weight ranges from between about 10 to about 40 percent, between about 10 to about 15 percent, between about 15 to about 20 percent, between about 20 to about 25 percent, between about 20 to about 30 percent, between about 25 to about 30 percent, between about 30 and about 35 percent, and between about 35 to about 40 percent.

The final texture of the food product in which these ingredients are used will be thicker and stiffer due to the binding of water soluble starches by the starches, pectin and proteins. The presence of globulins and albumins (proteins) exhibit excellent water and oil binding capacity. The presence of hydrocolloids and starches may reduce adhesiveness as the ingredients form a stable network structure that entraps starch granules, slowing down the amylose release during cooking. Hydrocolloids and starches also form a strong protein network, increasing the cohesiveness of the food product. The hydrophilic component in the hydrocolloids interacts ionically with the proteins in the food product to improve its structure in, e.g., a Traditional Burger Product or plant-only burger product.

The gums categories 1, 2 and 3 may be used in any combination as components of one or more food products depending on the desired effects, including non-starch-versus starch-related hydrocolloid interactions. In some embodiments, when certain ingredients of the gum replacement systems are used together in a food product, they provide synergistic, enhanced or varied functionalities and properties in combination that any one gum replacement system may not offer.

Chickpea flour (starch and protein), tomato (or apple) pomace, and quince seed mucilage together will result in reduced cooking loss. In addition, tomato and/or apple pomace exhibits high water binding capacity providing a degree of control and enabling in the desirable rheology and textural properties of the burger or other food product. Chickpea protein, tomato (or apple) pectin, rice starch and quinoa flour together function as binders and thickening agents. Polysaccharides and proteins interact with each other via electrostatic interaction, hydrogen bonding or Van der Waals forces depending on physical factors such as pH and temperature.

Surface active proteins can play a role in the formation and stabilization of emulsions in the presence of polysaccharides, while interacting through electrostatic or hydrophobic-hydrophobic interactions. Polysaccharides and proteins both contribute to the textural and structural properties by changing the rheology through their gelling networking system, water retention properties. With this basis, the desired properties can be attained for combining chickpea proteins and pectin. Apple pomace (pectin) and chickpea proteins combine together and form soluble complexes that aid efficient protein solubility and thermal stability. Both have better water retention properties that aid in binding action apart from the emulsification and stabilization provided to the burger components.

Pectins and proteins interact to increase viscosity of the consumable food product such as a plant-only burger product. The optimum combination of proteins and pectin and starch, increased hardness, gumminess, chewiness and optimum cohesiveness can be achieved. Further, proteins and pectins interact to form complexes that can bind water and fat together, which can contribute to maintaining food yield (and reducing shrinkage) during cooking. Increased protein level from quinoa and chickpea flours also reduce the adhesiveness. Pectin and starches in the replacement system provide structure to the food product. The addition of apple pomace (pectin) also may improve storage life of consumable food products.

Chickpeas and other legumes, when mixed with quinoa starch or quince seed mucilage act as a binding agent combination, and develop a strong protein-starch network with other ingredients, promoting structural stability and integrity in the consumable food product. Although quinoa is a low-fat protein source, it has a higher fat content than wheat and other grasses. It contains oleic and alpha-linolenic acids, both heart-healthy, monounsaturated fats that contribute to reduced cooking loss and discoloration of the consumable food product. Hydrocolloids in the gum replacement system ingredients form a strong network and interact with other components in food products. In either Traditional Burger Products or plant-only burger products, the gum replacement system ingredients, and/or substitutes exhibiting the same or similar functionalities and properties, promote structural stability and integrity of the food product.

The single ingredients of the gum replacement system and their various combinations along with their Ayurvedic properties (as shown in Table 3) results in a plant only (category 3) gum replacement system that may be use in whole or part in any variety of food products, the primary example of the disclosed embodiments for Traditional Burger Products and other, plant-only burger products. Alone or in combination as a gum replacement system, the previously described ingredient categories are effective and natural components in the gum replacement system for burger products, baked products or other food product categories in an amount of about 0.05 percent to up to 25 percent or more by weight of the food product, depending on the type of food product and the replacement ingredients needed or desired, as indicated above in the paragraph following Table 2. Table 2 above shows preferred weight range percentages within a plant-only burger product for the gum replacement system(s) (in some embodiments between about 10-15% dry weight of the burger product), as well as for other replacement systems and categories of other replacement ingredient combinations. The replacement system may be incorporated in much lower amounts in other food products. In some embodiments, Traditional Burger Products including so-called plant-based burger products may have a much lower quantity of gum replacement system ingredients, e.g., in some embodiments within a range between about 0.1 to about 2 percent (dry weight) of the weight of the food product.

Table 4: Plant-Only Gum Replacement System Categories of Ingredients and their Properties

The combination of categories and ingredients comprising a gum replacement system for traditional ingredients and additives in commercially available animal- and plant-based products, as well as their physicochemical and Ayurvedic properties are shown in Table 4.

| Ingredients and their Sources | | |
|---|---|---|
| Responsible for the Desired | | Ayurvedic |
| Functionality | Physicochemical properties | properties |
| Almond polysaccharides | pH: 3.9 to 4.4 | Rasa: |
| Almonds are mainly composed | Moisture: 12.5 to 15.0% | Madhura |
| of 92.36% of polysaccharides | Bulk Density: 0.6 g/ml | (sweet); |
| (dry weight basis) with the major | Porosity (%): 42.06 | Guna: Snigdha |
| sugar composition being | Stability: Similar to that of gum | (slimy); Guru |
| arabinose (46.83%), galactose | arabic. The stability of 10% oil | (heavy); |
| (35.49%) and uronic acid | emulsions with almond | Virya: Ushna |
| (5.97%). Almonds also | polysaccharides is comparable | (hot); |
| contain ~2.45% protein. | to those using gum arabic. | Vipaka: Madhura |
| | | (Sweet) |
| Quince seed mucilage | Moisture: 5.8% | Rasa: |
| The main fraction of Quince | Viscosity at shear rate: 46.16 | Madhura |
| seed mucilage is high- | 1/s 1473.96 mPa · s | (Sweet); Titka |
| molecular-weight | Emulsion stability: 94.89% | (Bitter); |
| polysaccharides and the most | Foam stability: 21.36% | Kashya |
| abundant among them include | Zeta potential measurement: | (Astringent); |
| d-Xylan, which contains large | The absolute values of zeta | Guna: Laghu |
| amounts of glucuronic acid | potential measurements of | (Light); |
| residues. Quince seed mucilage | Quince seed mucilage are | Ruksha (Dry); |
| also contains protein (2.2%), | greater than 30 mv, indicating | Virya: Ushna |
| which may affect the interfacial | an emulsion system with good | (Hot); Vipaka: |
| tension at the oil-water interface; | physical stability | Katu |
| interfacial tension directly affects | | (Pungent) |
| the emulsification stability. | | |
| Tomato pomace pectin has high | pH - 2.0 | Rasa: |
| protein (32.2%), fat (17.1%) and | Galacturonic acid: 77% | Madhura(Sweet); |
| carbohydrate (47%) content, with | Swelling capacity of TFP: 4.5 | Sour(Amla); |
| low ash (2.5%). Leucine in | mL/g | Guna: Guru |
| tomato peel/fiber pectin (TFP) is | Water holding capacity: 3.6 | (Heavy to |
| the main amino acid (1.46 g/100 | mL/g | digest); Virya: |
| g protein). Essential fatty acids | | Sheeta (Cold); |
| represent 58.4% of total fatty | | Vipaka: |
| acids, with linoleic acid as the | | Sour(Amla) |
| most abundant (55.8%). | | |
| In general, pectins help form | Oil holding capacity: 2.65 | |
| small droplet size emulsions, | mL/g. | |
| showing higher stability and | Increasing tomato pomace | |
| formed gel-like matrices. | pectin content maintains | |
| Insoluble fibers maintain | cooking yield (with a cooking | |
| emulsion stability through the | loss of only 27.8%). The pectin | |
| pickering mechanism and | in tomato peel increases | |
| network formation in the | springiness, while cellulose and | |
| continuous phase, likely favored | lignin increase chewiness of a | |
| by stabilization of proteins and | burger, for example. | |
| pectins in the soluble fraction. | High beta carotene and lycopene | |
| | content are natural colorants. | |
| Chickpea flour provides | Moisture: 9.6% | Rasa: |
| significant amounts of | Bulk Density: | Madhura |
| carbohydrates and protein. The | 410-510 Kg/m3 | (Sweet), |
| carbohydrates primarily are in | Porosity: 65-71% | kashaya |
| the form of starch (93-98%). | Peak viscosity: 1348-2163 | (Astringent); |
| Protein isolates (72-85% of | mPa · s | Guna: Laghu |
| proteins): include mainly | Final Viscosity: 1515-2704 | (light) Ruksha |
| globulins and albumin, which | mPa · s | (dry) |
| form matrices that bind and | Chick pea protein isolates' | Virya: Hima |
| retain water. | lowest gelation concentration: | (Cold) |
| | 10-14% | |
| | Water holding capacity: | |
| | 2.34-4.31 g/g | |
| | Oil absorbing capacity: 3-6 g/g | |
| | Emulsion stability: 18-26% | |
| | Emulsion activity: 0.9-1.3% | |

TABLE 5
Typical formulation for commercially available meat-based burgers

| | Weight | |
|---|---|---|
| Meat-based | percent | |
| Ingredient/category | of burger | Function |
| Beef/Pork | up to 60-70 | Meat-based protein |
| | | and fat source |
| Water | up to 10 | Moisture |
| Beef Fat | up to 15-20 | Animal fat source |
| Soy Protein | up to 10-15 | Protein source |
| Salt | up to 10-15 | Flavor |
| Caramel color | 5-15 | Colorant |
| Sodium | 2-4 | Stabilizer, meat curer |
| polyphosphates | | |
| Maltodextrin | 0.25-0.75 | Fat replacer, shelf life extender |
| Cochineal carmine | 5-15 | Colorant |
| Monosodium glutamate | 0.1-0.8 | Flavoring agent |
| Onion | 5-10 | Preservative, flavor enhancer |
| Garlic | 5-10 | Preservative, flavor enhancer |
| Cumin | 1-5 | Preservative, flavor enhancer |
| Sodium erythorbate | 0.5-0.7 | Cure accelerator |
| Natural beef/pork flavors | 1-2 | Flavor |
| Sodium citrate | 2-3 | Acidity regulator |
| Disodium inosinate | 0.1-0.3 | Flavor enhancer |
| Sodium guanylate | 0.1-0.3 | Flavor enhancer |
| Black pepper | 1-5 | Flavor enhancer |
| Capsicum | 1-5 | Flavor enhancer |
| Soybean | up to 10-40 | Textured vegetable protein |
| Nisin | 0.01-0.05 | Preservative |
| Nitrites and Nitrates | 1-5 | Taste, colorant, antimicrobial |
| Phosphate Salts | 0.1-0.5 | Moisture retention, stabilizer, |
| | | shrinkage reducer, |
| | | flavor enhancer, |
| | | colorant |
| Tertiary | 0.02-0.03 | Antioxidant |
| butylhydroquinone | | |
| (TBHQ) | | |

In some embodiments, the gum replacement system when added to plant-based products within the Traditional Burger Products such as in the example above, replaces any gums, maltodextrin and a small percent of soybean, in an amount between about 0.1 and about 2 percent of the weight or, in other embodiments up to about 5 percent or more of the plant-based burger product alone.

TABLE 6
Typical formulation for commercially
available, plant-based burgers

| | Weight | |
|---|---|---|
| Plant-based Burger | Percent | |
| Ingredient/Category | of Product | Function |
| Pea protein isolate | 70-80 | Protein source |
| Water | Variable | Moisture |
| Expeller-pressed canola | 2-5 | Fat source |
| oil | | |
| Refined coconut oil | 20-25 | Fat source |
| Cellulose from bamboo | ≤2 | Texturizer |
| Methylcellulose | 0.1-2 | Thickener, emulsifier |
| Potato starch | 2-4 | Thickener |
| Flavoring agents | 10-15 | Flavor |
| Maltodextrin | 0.2-0.9 | Fat replacer, shelf life extender |
| Yeast extract | 1-2 | Flavor enhancer |
| Salt | 2-5 | Flavor |
| Sunflower oil | 8-10 | Fat source |
| Vegetable glycerin | 5-15 | Sweetener |
| Dried yeast | 1-3 | Flavoring agent |
| Gum arabic, konjac gum, | 0.1-1 | Emulsifier, stabilizer, thickener, |
| xanthan gum, | | foaming agent, |
| Locust bean | | texturizer, moisture |
| gum, carrageenan | | retention. |
| Citrus extract (to protect | 1-3 | Antimicrobial, preservative |
| quality) | | |
| Ascorbic acid (to | 0.1-1 | Color retention |
| maintain color) | | |
| Beet juice extract (for | 5-10 | Colorant |
| color) | | |
| Acetic acid | 0.5-2 | Shelf life extender |
| Succinic acid | 1-2 | Acidulant/flavoring agent |
| Modified food starch | 5-15 | Texturizer |
| Annatto (for color) | 2-5 | Colorant |

Table 6 provides an overview of the typical formulation of a commercially available, plant-based burger or burger mix, with numerous chemical additives. Although a somewhat improved profile compared to the profile of the formulation of the meat-based burger shown in Table 5, it can be improved for certain consumer diets with the use of plant-only replacements such as the methylcellulose replacement system. The methylcellulose replacement system may also be used to improve the quality of meat-based food products intended for pets and other animals.

TABLE 7
Comparison of formulations of plant-based burgers and burger mixes versus
commercially available plant-only burgers and burger mixes, indicating
relevant replacements for traditional additives in plant-based burger

| Example Formulation of Commercially | Plant-only Formulation for Burger |
|---|---|
| Available Plant-based Burger Products | Products Replacing methylcellulose and |
| with Traditional Additives | other Traditional Additives |
| Pea protein isolate | One or more protein source(s) (peas, lupine, |
| | mushrooms, quinoa, chickpea, etc.) |
| Water | Water (from plant or external source) |
| Expeller-pressed canola oil | One or more oils (sunflower, coconut, |
| Refined coconut oil | flaxseed and rice bran, etc.) containing high |
| Sunflower oil | levels of MUFAs, omega-3 fatty acids, & |
| | MCTs |
| Cellulose from bamboo | Plant-only methylcellulose replacement |
| Methylcellulose | system (blend of five categories of |
| | ingredients: protein, fibers from whole |
| | grains; fibers from fruits, seeds and |
| | vegetables, vegetable binding agents and |
| | starches as shown in Tables 2 & 3) (0.5-30% |
| | weight of the plant-only burger product |
| | depending if water or other liquid is |
| | included in the burger product). |
| Annatto (for color) | Plant-only flavorants, nutraceuticals |
| Natural flavor | (one or more of cumin, coriander, paprika, |
| | black pepper, etc.) |
| | Plant-only umami flavor replacement |
| | system (one or more of shiitake and other |
| | mushrooms, onions, tomatoes, lotus stem, |
| | garlic mineral salts, etc.) |
| Maltodextrin | Plant-only shelf life extender |
| | (one or more of garlic, black pepper, |
| | oregano, bay leaf etc.) |
| Yeast extract | Flavor enhancer (one or more of nutritional |
| Vegetable glycerin | yeast, cashews etc.) |
| Dried Yeast | Plant-only leavening agent replacement |
| | system (one or more of psyllium husk, apple |
| | pomace, rice starch, faba beans, plum |
| | powder, etc.) |
| Salt | Mineral Salts (Himalayan pink salt, sea salt, |
| | etc.) |
| Gum arabic, konjac gum, xanthan gum, | Plant-only gums and carrageenan |
| locust bean gum, carrageenan | replacement system (one or more of quince |
| | seed, apple, mesquite, almond, etc.) |
| Citrus extract (to protect quality) | Plant-only leghemoglobin (one or more of |
| Ascorbic acid (to maintain color) | beets, red radish, etc.) |
| Beet juice extract (for color) | |
| Acetic acid | Plant -only shelf life extender (one or more |
| | of garlic, black pepper, onion, etc.) |
| Succinic acid | Plant-only flavor enhancer (one or more of |
| | paprika, black pepper, beet juice, etc.) |
| Modified food starch | Plant-only modified starches replacement |
| Potato starch | (one or more of tapioca, fava bean, |
| | sorghum, quinoa, etc.) |

### Functionality of Replacement Systems for Burger Products

The unique combination of essential ingredients in each plant-only replacement system, including individual ingredients or combinations of ingredients within each category of the system provides certain functionalities necessary for quality, plant-only burger products, as shown in the following table 8.

TABLE 8
Functionalities Provided by Plant-Only Replacements in Burger Products

| | Plant-only | |
|---|---|---|
| | Burger Product | Plant-Only Ingredients, Ingredient |
| | Essential | Combinations or Replacement Systems |
| | Ingredients and | Enabling Functionality within the Burger |
| Function | Combinations | Product Compnositio |
| Emulsifier | One or more oils | Sunflower oil is primarily (85%) unsaturated |
| | providing high | fatty acids comprising 14-43% oleic acid |
| | levels of | and 44-75% linoleic acid, the latter, which |
| | MUFAs, omega | results in the oil's lower freezing point, and |
| | 3 fatty acids, & | contributes to the lower freezing points of |
| | MCTs (sunflower | products in which sunflower oil is added. |
| | oil, coconut oil, | Coconut oil, in contrast, is ~87% saturated |
| | flaxseed oil, rice | fatty acids, lauric acid accounting for ~49% |
| | bran oil, or other | of the saturated fats. Other saturated fatty |
| | oil substitute | acids include myristic, palmitic, stearic, |
| | exhibiting the | oleic, capric and caprylic acids. |
| | same or similar | Flaxseed comprises ~35-45% oil and |
| | properties and | 20-30% protein. The oily portion consists of |
| | functionality) | 9-10% saturated fatty acids (palmitic and |
| | | stearic), ~20% monounsaturated fatty acids |
| | | (mainly oleic acid), and more than 70% |
| | | alpha-linolenic fatty acids acid. |
| | | Rice bran oil consists of ~74% unsaturated |
| | | fatty acids (~30% linoleic acid, ~44% oleic |
| | | acid), and the remaining ~23% are saturated |
| | | fatty acids. |
| Thickening | Thickeners and | Chickpea fractions (starch, proteins) |
| agents/ | binding agents | function as binders and are also a protein |
| binding | (one or more of | source (72-85% are globulins and albumin. |
| agent | chickpeas, oat | Protein matrices formed have the ability to |
| | fiber, passion | hold water and fat. Their binding properties |
| | fruit, aquafaba, | are also attributable to water soluble and |
| | sugar beet pectin, | insoluble carbohydrates: cellulose, starch |
| | and/or | and hemicellulose. Soluble carbohydrates |
| | substitute(s) with | have higher water binding capacities, and |
| | the same or | water soluble- and insoluble polysaccharides |
| | similar | also absorb oil. |
| | functionality and | Oat fiber retains water, decreases cooking |
| | properties) | losses and has neutral flavor. Oats have a |
| | | fiber type of β-glucan, a soluble fiber |
| | | accounting to 4%. It depicts functional |
| | | properties as a potential binding agent. Oat |
| | | fiber provides the flavor, texture and |
| | | mouthfeel of fat. |
| | | Passion fruit has a high proportion (52%) of |
| | | insoluble dietary fiber (cellulose, |
| | | hemicellulose, and pectin), which |
| | | contributes to strong fat and water retaining |
| | | abilities. The fruit contains moderate length |
| | | cellulose fibers, contributing to a moderate |
| | | ability to retain fat. Cellulose interlinks |
| | | with hemicellulose and forming a fiber net, |
| | | increasing the surface area of individual |
| | | fibers, and contributing their water and oil |
| | | retention properties. |
| Texturizer/ | Modified starch | Tapioca starch is an excellent thickener, |
| gelling agent | replacement | binder, texturizer and stabilizer. Sometimes |
| | system (one or | called tapioca flour, this starch originates |
| | more of tapioca | from the cassava plant. |
| | starch, faba bean, | Gelatinized (tapioca) starch can hold a |
| | sorghum starch, | significant amount of water, which helps |
| | quinoa starch, | improve the texture of many food products, |
| | rice starch or | including burgers and burger mixes. |
| | substitute | The faba bean protein is glossy and sticky, |
| | exhibiting the | and is an important emulsifier, foam |
| | same or similar | stabilizer, and contributes to gel formation. |
| | functionality and | Its protein constituents include globulin and |
| | properties) | albumin accounting for ~25-30% of its |
| | | content; these proteins do not contribute as |
| | | much as the other constituents to the gelling |
| | | capacity. |
| | | The quinoa starch is relatively low in |
| | | amylose content (e.g., 11%), and has very |
| | | small granules (1 to 3 μm) The starch has |
| | | unique properties such as low pasting |
| | | temperature, high freeze-thaw stability, and |
| | | water holding capacity. The protein from |
| | | quinoa flour helps provide structure and |
| | | shape to the system. The protein and starch |
| | | both contribute to the gelling property. |
| | | Sorghum starch consists mainly amylopectin |
| | | and amylose. While heating, the |
| | | gelatinization of starch occurs due to |
| | | hydrogen bonds being broken within the |
| | | starch granule due to water influx, which |
| | | results in granular swelling, increasing |
| | | viscosity, which thickens and texturizes the |
| | | food product. |
| Shelf life | Plant only shelf | Garlic (Allium sativum) is one of the |
| extender; | life extenders | commonly used plants to enhance flavor. It |
| preservative, | (any one or more | produces a wide spectrum of actions which |
| flavoring | of herbs and | have led to its use as an antibacterial, |
| agent, | spices, including | antifungal, and antioxidant agent. The |
| stabilizer | garlic extract, | presence of allicin, a sulfur-containing |
| | Himalayan pink | compound, is responsible for the |
| | salt; black | antimicrobial effects. |
| | pepper, oregano, | Himalayan pink salt contains substantially |
| | bay laurel and/or | higher levels of calcium, iron, magnesium, |
| | any substitute(s) | manganese, potassium, aluminum, barium, |
| | that exhibit the | silicon, and sulfur, but lower levels of |
| | same or similar | sodium compared to the white table salt |
| | functionality and | Black pepper, Piper nigrum, has piperine in |
| | properties) | higher amounts that enables the |
| | | antimicrobial activity. Terpenes and |
| | | flavonoids also contribute to its activity. The |
| | | essential oil content in black pepper mainly |
| | | consists of caryophyllene (30.3%) and |
| | | limonene (12.12%), both of which also |
| | | contribute to its antimicrobial activity. |
| | | Oregano, Origanum vulgare, along with its |
| | | flavor imparting action, contributes to |
| | | antimicrobial and antioxidant properties. |
| | | The major components of oregano essential |
| | | oil are carvacrol, β-fenchyl alcohol, thymol, |
| | | and γ-terpinen. These compounds have a |
| | | free radical scavenging effect contributing to |
| | | enhanced shelf life. |
| | | Bay leaf contains 1.3% essential oils that |
| | | contribute to both flavor and shelf life |
| | | enhancement. These oils include primarily |
| | | eucalyptol (45%) but also other terpenes |
| | | (~12%), terpinyl acetate (8-12%), |
| | | sesquiterpenes (3-4%), methyl eugenol |
| | | (3%), and smaller amounts of other α- and |
| | | β-pinenes, phellandrene, linalool, geraniol, |
| | | terpineol and lauric acid. These compounds |
| | | exhibit radical scavenging and antimicrobial |
| | | activity. |
| Flavoring | Umami flavor | Meat and other animal-based products can |
| agent/ | source(s) (one or | be replaced in some food products with one |
| umami | more of shitake | or more types of mushrooms without |
| flavor | and other | compromising flavor, and can improve |
| | mushroom types, | nutritional quality by reducing sodium, |
| | onions, tomatoes, | calories, saturated fat, and cholesterol |
| | garlic, lotus stalk, | content. Mushrooms impart an “umami” |
| | salt, and/or any | flavor because of their flavor-enhancing |
| | substitute(s) for | compounds, most noticeably the eight |
| | these exhibiting | carbon (C8) volatile compounds. Among all |
| | the same or | C8 compounds, the most important for |
| | similar | mushroom flavor are oct-1-en-3-ol, octan-3- |
| | functionality and | ol, octan-3-on and oct-1-en-3-on. |
| | properties) | Onion (Allium cepa L.) contains high levels |
| | | of flavonoids that enhance the flavor of food |
| | | products. Onions contribute to the umami |
| | | flavor of food with their high glutamic acid |
| | | content (~25 to 50 mg/100 g). |
| | | Tomatoes impart a unique flavor, the result |
| | | of a complex mix and interaction among |
| | | sugars, acids, and volatile compounds. They |
| | | also are high in g |
| | | lutamate (~250 mg/100 g). |
| Flavorants, | One or more | Paprika oleoresin contains a number of |
| flavor | flavorants, flavor | carotinoids and pigments, including, among |
| enhancers, | enhancers, | others, capsanthin and capsorubin, which are |
| nutraceutical | nutraceuticals | strong antioxidants. Paprika is low in |
| | (one or more of | capsaicin, the pungent (hot) compound |
| | herbs and spices | found in red peppers. Methoxypyrazines” in |
| | such as cumin, | paprika are responsible for its vegetative |
| | paprika, | flavor. The sweetness of paprika comes |
| | coriander, black | from a sugar content (up to 6%). Paprika has |
| | pepper, onion, or | important bioactive compounds such as |
| | a substitute(s) | carotenoids, quercetin glycosides, and |
| | that exhibit the | luteolin, all of which exhibit high |
| | same or similar | antioxidant activity. |
| | functionality and | Onions (Allium cepa L.) contain |
| | properties) | phytonutrients such as: flavonoids, |
| | | fructooligosaccharides (FOS), thiosulfide |
| | | and other sulfur compounds, which are |
| | | recognized as important elements of highly |
| | | nutritional molecules. Quercetin is the main |
| | | flavonoid present in onions, exhibiting |
| | | antioxidant and antimicrobial properties. |
| | | Black pepper (P. nigrum) contains numerous |
| | | flavor compounds and has antimicrobial and |
| | | antioxidant properties. The primary volatile |
| | | flavor compounds include terpenes: |
| | | monoterpene hydrocarbons (59.2-80.1%) |
| | | and sesquiterpene hydrocarbons |
| | | (17.0-37.7%) while oxygenated terpenoids |
| | | accounted for about 1.3-2.7%. Key |
| | | odorants of black pepper are α- and β- |
| | | pinene, myrcene, α-phellandrene, limonene, |
| | | linalool, methyl propanal, 2- and 3- |
| | | methylbutanal, butyric acid, germacrene, |
| | | and 3-methylbutyric acid. The spiciness of |
| | | black pepper comes from Piperine. |
| | | Germacrene is potent, spicy, warm and has a |
| | | sweet aroma. In contrast, limonene is sweet, |
| | | orange, citrus and terpy. The essential oil |
| | | content in black pepper mainly consists of |
| | | caryophyllene (30.3%) and limonene |
| | | (12.12%) also contribute to antioxidant |
| | | activity. |
| | | Cumin is a seed spice belonging to the |
| | | family Umbelliferae. Cumin and products |
| | | flavored by cumin are used in food products |
| | | and perfumery. Cumin contains ~2.3 to |
| | | 4.8% of volatile oils. The characteristic odor |
| | | of cumin is mainly due to the aldehydes |
| | | present in the seeds, namely, cuminaldehyde |
| | | (45-50%), p-menth-3-en-7-al and p-menth- |
| | | 1,3-dien-7-al. Other major compounds |
| | | present in cumin contributing its distinct |
| | | flavor include: cuminal (8-17%), β-pinene |
| | | (22-27%), β-myrcene (1.3-1.75%), ρ- |
| | | cymene (23-39%), γ-terpinene (11-27%), |
| | | and ρ-mentha-1,4-dien-7-ol (1.0-5.5%). |
| | | Coriander, Coriandrum sativum, has a |
| | | characteristic flavor is due to terpenes. The |
| | | essential oils present in oil glands in the |
| | | mericarp and the linalool, with its floral and |
| | | pleasant scents also contribute to flavor |
| | | enhancement. |
| | | Phenolics compounds present in the |
| | | coriander seeds such as gallic acid, caffeic |
| | | acid, ellagic acid, quercetin, kaempferol |
| | | contribute to the antioxidant activity. |
| Thickener, | MC | Pea fiber contains insoluble fibers and |
| Binding | replacement | higher protein content, which contribute to |
| agent, | system: | its ability to hold water. The combination of |
| Stabilizer | ingredients from | protein and fiber also leads to the higher oil |
| | all five categories | absorbing capacity. Peas contain a high |
| | (proteins; fibers | amylose starch content (25-29%) that |
| | from whole | enables it to bind water and oil. |
| | grains, fruits, | Oat fibers retain water, decreases cooking |
| | seeds and | loss, and it has a neutral flavor. Oats contain |
| | vegetables; | 4% (by weight) of β-glucan, a soluble fiber |
| | starches; and | with potential binding abilities. Oat fiber |
| | vegetable | provides flavor, texture, and mouthfeel of |
| | binders) and/or | fat. In addition, β-glucan also contains |
| | any substitute(s) | hydrocolloids that provide emulsion |
| | that exhibit the | stability, modifying the gelation process and |
| | same or similar | increasing viscosity. β-glucan forms a |
| | properties and | porous network in a protein-gel matrix, e.g., |
| | functionalities | holding fat globules in the burger system. |
| | | Chickpeas contain starch and protein, and |
| | | act as binder and stabilizer. Chickpea |
| | | proteins include globulins and albumin, |
| | | which act as binding proteins; these binding |
| | | proteins constitute 72-85% of the weight of |
| | | the chickpea, and function as thickeners and |
| | | binders by forming protein matrices that |
| | | hold water and fat. |
| | | Quinoa starch is relatively low (e.g., 11%) in |
| | | amylose and appears as small granules (1 to |
| | | 3 μm). Quinoa starch has unique properties: |
| | | low pasting temperature, high freeze-thaw |
| | | stability, and water holding capacity. The |
| | | Quinoa starch granules are small, polygonal, |
| | | and in the range of 0.5-3 μm; they function |
| | | as a stabilizer for creating pickering |
| | | emulsions. The proteins from quinoa flour |
| | | help provide structure and shape to the food |
| | | product. |
| Hydro | Gum | The main fraction of quince seed gum are |
| Colloids- | replacement | high-molecular-weight polysaccharides, the |
| gelling, | system(s) | most abundant among them which is d- |
| emulsifier , | (categories 1, 2 | Xylan, with many glucuronic acid residues. |
| stabilizer, | and/or 3) | The presence of proteins in quince seed gum |
| sequestrant | (Category 3: one | (2.2%) affects the interfacial tension at the |
| | or more of | oil-water interface and contributes to its |
| | almond | ability to act as an emulsifier. |
| | polysaccharides, | Almond is mainly composed of 92.36% of |
| | quince seed | polysaccharides (dry weight basis) with the |
| | mucilage, tomato | major sugar composition comprising: |
| | pomace (pectin) | arabinose (46.83%), galactose (35.49%) and |
| | and chickpea | uronic acid (5.97%). It also contains a small |
| | flour (starch and | amount of protein (2.45%) |
| | protein) chickpea | Quinoa: starch is the main component (up to |
| | protein and | 70% dry weight) of the quinoa grain. Starch |
| | starch and apple | plays a crucial role in functional properties |
| | pomace (pectin) | of quinoa and related food products. The |
| | and/or | small starch granules (~1-3 um) exhibit a |
| | substitute(s) that | low amylose content versus most of the |
| | exhibit the same | other starches. |
| | or similar | Chickpea starch and protein form matrices |
| | properties and | that hold water contributing to gelling |
| | functionalities) | capacity. |
| | Other gum | Mesquite proteins are a complex |
| | replacement | carbohydrate and protein mix and is |
| | systems | comprised of D-galactose, L-arabinose, D- |
| | (categories 1 and | glucuronate, D-mannose and D-xylose. |
| | 2) are discussed | Apple pomace (pectin) is a low methyl |
| | in separate | cellulose-containing pectin, and forms a |
| | disclosures, | thermo-irreversible gel, remaining in a gel |
| | although the | consistency even at high temperatures that |
| | preferred | would normally melt pectin. Pectin aids in |
| | ingredients of | the formation of smaller droplet size |
| | each can be | emulsions, showing higher stability and |
| | found in Table 6 | forming a gel-like consistency. The action |
| | above. | of the insoluble fibers in pectin maintain |
| | | their stability in emulsions through |
| | | pickering mechanism and through network |
| | | formation in the continuous phase; this may |
| | | be favored by stabilization of proteins and |
| | | pectin in the soluble fraction. |
| | | Tomato pomace (pectin), a by-product of |
| | | processing tomatoes for juice and sauce, his |
| | | high in protein, and carbohydrates and fat. |
| | | Leucine in tomato peel/fiber pectin (TFP) is |
| | | the main amino acid (1.46 g/100 g protein). |
| | | Essential fatty acids represent 58.4% of |
| | | total fatty acids, with linoleic acid as the |
| | | most abundant (55.8%). Due to the higher |
| | | level of fat present in the TFP, it reduces |
| | | cooking loss and shrinkage of meat- or |
| | | plant-based (or plant-only) food products |
| | | such as burgers. |
| Flavoring | Flavor enhancer, | Nutritional yeast is a food additive made |
| agent | nutritional yeast | from a single-celled organism, |
| | (one or more of | Saccharomyces cerevisiae, a member of the |
| | nutritional yeast, | fungi kingdom. This yeast is grown on |
| | cashews and/or | molasses and then harvested, washed, and |
| | any substitute(s) | dried with heat to kill or deactivate it. |
| | for either one that | Cashews contain esters (methyl 3-methyl |
| | exhibits the same | butanoate, ethyl 3-methyl butanoate, methyl |
| | or similar | butanoate, ethyl butanoate, ethyl trans-2- |
| | functionality and | butenoate and methyl 3-methyl pentanoate) |
| | properties) | which impart a sweet, fruity taste and |
| | | aroma. |
| Leavening | Leavener | Apple cider vinegar is the fermented juice of |
| agent(s) | replacement | crushed apples, containing acetic acid, |
| | system | which contributes to the leavening action in |
| | (ingredients from | food products. |
| | five categories, | Dried plums contain about 2% naturally |
| | including one or | occurring malic acid, which serves as the |
| | more of plum | natural acid component of chemical |
| | powder, apple | leavening systems. Dried plums can also act |
| | cider vinegar, | as a natural preservative, inhibiting |
| | vegan buttermilk, | microbial spoilage. |
| | and/or any | Vegan buttermilk is made by combining |
| | substitute(s) that | almond milk with acidulants. The high fat |
| | exhibit the same | content combined with acids result in |
| | or similar | curdling. |
| | functionality and | |
| | properties) | |
| Lipid | Lipid | Black pepper (P. nigrum) with piperine as |
| peroxidation | peroxidation | an active ingredient, holds rich |
| inhibitor, | inhibitors (one or | phytochemistry that also includes volatile |
| antioxidant, | more of black | oil, oleoresins, and alkaloids. Black pepper |
| flavor | pepper, bay leaf, | oleoresins impart taste and exhibit |
| enhancer | cumin, and/or | antioxidant properties. They are also used as |
| | any substitute(s) | a colorant and a food preservative because |
| | that exhibit the | of their antimicrobial properties. β- |
| | same or similar | Caryophyllene, limonene, β-pinene, α- |
| | functionality and | pinene, δ-3-carene, sabinene, and myrcene |
| | properties) | are the main components of this oil. |
| | | Bay leaves showed radical scavenging |
| | | activity due to the presence of sesquiterpene |
| | | lactones, alkaloids, and glycosylated |
| | | flavonoids. The kaempferol C-glycoside is |
| | | the major contributor to antioxidant |
| | | properties. |
| | | Cumin's antioxidant activity is correlated |
| | | with the presence of high polyphenols, |
| | | mainly flavonoids. The essential oils |
| | | present - carvacrol, anethole, and terpineol - also |
| | | contribute to the function of radical |
| | | scavenging. |
| Color | One or more | Leghaemoglobin is a protein that binds |
| retention, | sources of | oxygen and is found in the root nodules of |
| coloring | leghaemoglobin | leguminous plants; it is often used as an |
| agent, nitrite | (one or more of | ingredient in some plant-based meat |
| replacement | beets, red | substitutes. |
| | radishes and/or | Red beet - B. vulgaris - is one of the top ten |
| | any substitute(s) | most potent antioxidant-rich vegetables. |
| | that exhibit the | Betalains (including betanin/betanidin) |
| | same or similar | exhibit high antioxidant activity. Red radish |
| | functionality and | and beet powders exhibit antioxidant |
| | properties) | activity and are high in nitrates. Radish |
| | | powder in particular prevents meats and |
| | | meat substitutes from changing color. |

### Preparation of the Gum Replacement System or its Component Categories

At step 102, a) 20-30% by weight of a plant-derived polysaccharide source, b) 15-25% by weight of a plant-derived mucilage source, c) 20-30% by weight of a plant-derived pectin source, and d) 5-15% by weight of a plant-derived starch and protein source are mixed at a temperature between 60 degrees Celsius and 105 degrees Celsius for about 30 seconds to one minute to form the plant-only gum replacement system.

In one embodiment the gum replacement system, individual ingredients or combinations of ingredients can be prepared by combining and mixing the dried, powdered ingredients selected from Table 1 in the relative amounts identified as preferred, essential ingredients of the system to be used in a desired food product. In some embodiments the gum replacement system may be in the form of a liquid or gel due to the addition of water or other plant-derived liquid to one or more of the ingredients or categories of ingredients before mixing, such as, for example, aquafaba in liquid form. In some embodiments the gum replacement system is mixed with additional water or plant-derived liquid, then dried and powdered and stored. In some embodiments the gum replacement system is prepared in liquid form and freeze dried. In certain embodiments, the gum replacement system may be prepared and stored as a liquid or moist form (as in a gel or dough). In certain other embodiments the gum replacement system may be prepared as a liquid, gel or in dried form and then frozen for storage. In other embodiments, each of the categories of ingredients, individual ingredients, or combinations of ingredients within each of the categories of the gum replacement system, whether in liquid, gel, dried or other form, are mixed individually directly into and become a part of another food product rather than being combined as the complete replacement system prior to incorporation into another food product.

In some embodiments the gum replacement system stands alone as a plant-only food product that can be added to one or more ingredients or other food replacement systems to form any type of consumable food product requiring one or more plant-only gum replacements. In other embodiments the gum replacement system is a component of a plant-only burger product, or other imitation meat product. In certain embodiments the gum replacement system is a component of a baked good food product, or a frozen burger or burger mix, which may then be incorporated into other food products. In still other embodiments the food product is one of several components used to create final food product. In other embodiments the food product is a Traditional Burger Product. In some embodiments, the ingredients of Table 1 may be selected and combined in other relative amounts (a variety of ranges) identified for each of the four gum replacement system ingredients discussed infra to achieve the required functional characteristics most closely resembling those of conventionally used gums in a variety of food products, including, e.g., Traditional Burger Products.

In some embodiments, the Almond polysaccharides is prepared by grinding the almonds using a grinder. Fruit powder was added to a 1000 mL beaker with 500 mL of water, and the mixture was heated and stirred at 60° C. for 4 hours. The concentrated solution was refrigerated at 4° C.-6° C. after being filtered through muslin cloth. By putting the gum into ethyl alcohol and filtering it through muslin cloth, the gum was isolated and precipitated. Gum was extracted of its oil, and then it was further dried to a consistent weight in a hot air oven at 35 to 45° C.

In some embodiments, the Quince seed mucilage is prepared by combining cleaning quince seeds with water. The amount of water to seed was predetermined to be 20:1 (v/w), and the mixture was agitated at 75 C for 3 hours. Muslin cloth was used to separate the seeds from the water. Three times, 96% ethanol was used to precipitate the mucilage, and then the precipitates were separated by centrifuging at 6500 rpm for 15 minutes. The mucilage (10.9% yield) was subsequently dried for 4 hours in an oven at 70 C.

In some embodiments, the Tomato pomace (pectin) is prepared by chopping tomatoes into four equal pieces after being thoroughly washed with clean water. Sliced tomatoes are placed in a juice extractor for mixing after the seeds have been removed. The remaining fibrous solid content is collected and used as the wet tomato pomace. It is further dried to be used as a powder.

In some embodiments, Chickpea flour (starch/protein) is prepared by soaking cleaned Chickpeas overnight or a minimum of 8 hours. Then the chickpeas are dried by placing them on a large dehydrator tray in the oven set at 50° C. for 12 hours. After which, they are ground in a high-speed food processor/blender.

Merely for illustration, only representative number/type of graph, chart, block, and sub-block diagrams were shown. Many environments often contain many more block and sub-block diagrams or systems and sub-systems, both in number and type, depending on the purpose for which the environment is designed.

While specific embodiments of the disclosed embodiments have been shown and described in detail to illustrate the inventive principles, it will be understood that the disclosed embodiments may be embodied otherwise without departing from such principles.

Throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment” and similar language throughout this specification may, but do not necessarily, all refer to the same embodiment.

It should be understood that the FIGURES and/or screen shots illustrated in the attachments highlighting the functionality and advantages of the disclosed embodiments are presented for example purposes only. The disclosed embodiments are sufficiently flexible and configurable, such that it may be utilized in ways other than that shown in the accompanying FIGURES.

It should be understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference in their entirety for all purposes.

What is claimed is:

1. A plant-only gum replacement system for use in food products comprising:
a) 20-30% by weight of a plant-derived polysaccharide source, b) 15-25% by weight of a plant-derived mucilage source, c) 20-30% by weight of a plant-derived pectin source, and d) 5-15% by weight of a plant-derived starch and protein source.

2. The plant-only gum replacement system of claim 1, wherein the plant-derived polysaccharide source is selected from almond polysaccharides, oat flour, quinoa flour, cassava flour, sunflower seeds flour, palm kernel meal, coconut flour, soya bean hulls, sugar beet pulp, pecan flour, cashew flour, macadamia flour or combinations thereof.

3. The plant-only gum replacement system of claim 1, wherein the plant-derived mucilage source is selected from quince seed mucilage, sweet basil seed mucilage, chia seed mucilage, yellow mustard mucilage, moringa seeds mucilage, fenugreek seeds mucilage, Cordia dichotoma seeds mucilage, arugula seeds mucilage, radish seeds mucilage, cress seeds mucilage, okra mucilage or combinations thereof.

4. The plant-only gum replacement system of claim 1, wherein the plant-derived pectin source is selected from tomato pomace, apple pomace, jujube pomace, redcurrant pectin, blackberry pectin, strawberry pectin, orange pomace, dragon fruit peel pectin, raspberry pectin or combinations thereof.

5. The plant-only gum replacement system of claim 1, wherein the plant-derived starch and protein source is selected from chickpea flour, pea flour, lupine flour, soy flour, pigeon pea, pinto beans flour, red lentils flour, lima beans, navy bean, mung bean, black gram flour, yellow pea flour or combinations thereof.

6. The plant-only gum replacement system of claim 1, wherein the food products comprise ice creams, pasta, processed cheese, tomato ketchup, soups, pastry ices, soft viscous candies, fruit-based and membrane-coated items, burgers, sausages, burger mixes, cakes, chocolate bars, and pancake mixes.

7. A method of preparing a plant-only gum replacement system for use in food products, wherein the method comprises:
mixing a) 20-30% by weight of a plant-derived polysaccharide source, b) 15-25% by weight of a plant-derived mucilage source, c) 20-30% by weight of a plant-derived pectin source, and d) 5-15% by weight of a plant-derived starch and protein source at a temperature between 60 degrees Celsius and 105 degrees Celsius for about 30 seconds to one minute to form the plant-only gum replacement system.

8. The method of claim 7, wherein the plant-derived polysaccharide source is selected from almond polysaccharides, oat flour, quinoa flour, cassava flour, sunflower seeds flour, palm kernel meal, coconut flour, soya bean hulls, sugar beet pulp, pecan flour, cashew flour, macadamia flour or combinations thereof.

9. The method of claim 7, wherein the plant-derived mucilage source is selected from quince seed mucilage, sweet basil seed mucilage, chia seed mucilage, yellow mustard mucilage, moringa seeds mucilage, fenugreek seeds mucilage, Cordia dichotoma seeds mucilage, arugula seeds mucilage, radish seeds mucilage, cress seeds mucilage, okra mucilage or combinations thereof.

10. The method of claim 7, wherein the plant-derived pectin source is selected from tomato pomace, apple pomace, jujube pomace, redcurrant pectin, blackberry pectin, strawberry pectin, orange pomace, dragon fruit peel pectin, raspberry pectin or combinations thereof.

11. The method of claim 7, wherein the plant-derived starch and protein source is selected from chickpea flour, pea flour, lupine flour, soy flour, pigeon pea, pinto beans flour, red lentils flour, lima beans, navy bean, mung bean, black gram flour, yellow pea flour or combinations thereof.

12. The method of claim 7, wherein the food products comprise ice creams, pasta, processed cheese, tomato ketchup, soups, pastry ices, soft viscous candies, fruit-based and membrane-coated items, burgers, sausages, burger mixes, cakes, chocolate bars, and pancake mixes.

13. The method of claim 7, wherein physical characterization data associated with ingredients of the plant-only gum replacement system comprising the plant-derived polysaccharide source, the plant-derived mucilage source, the plant-derived pectin source, and the plant-derived starch and protein source is stored in a database, wherein a machine learning model determines a unique combination of ingredients based on the physical characterization data to prepare the plant-only gum replacement system.

14. The method of claim 13, wherein the physical characterization data of the ingredients comprise functional properties that comprise emulsification properties, stabilization properties, gelling properties, fat-replacement properties, Ayurvedic and/or other holistic properties, physicochemical properties that comprise pH, viscosity, moisture content, density, mechanical properties that comprise adhesive strength, tensile strength, shear resistance, chemical and/or molecular descriptor properties that comprise bio-active/bioavailability properties, molecular structure, phytonutrient properties, sensorial properties that comprise taste, smell, color, texture, mouth feel, and nutritional information that comprises macronutrient/micronutrient properties.
